(19) United States
(12) Patent Application Publication
(10) Pub. No.: US 2018/0288824 A1
(43) Pub. Date: Oct. 4, 2018

(54) COMMUNICATION TERMINAL AND METHOD FOR TRANSMITTING A SIGNALING MESSAGE

(71) Applicant: Intel IP Corporation, Santa Clara, CA (US)

(72) Inventor: Marcus HOEPFNER, Nuremberg (DE)

(73) Assignee: Intel IP Corporation, Santa Clara, CA (US)

(21) Appl. No.: 15/762,612

(22) PCT Filed: Aug. 10, 2016
(86) PCT No.: PCT/US2016/046222

§ 371 Date: Mar. 23, 2018

(30) Foreign Application Priority Data
Sep. 25, 2015 (DE) 10 2015 116 221.0

(51) Int. Cl. H04W 76/16

(52) U.S. Cl. CPC H04W 76/16; H04W 88/06

(57) ABSTRACT

A communication terminal is described comprising a transmitter and a signaling circuit configured to, determine whether the transmitter is transmitting data according to a second radio access technology, while a signaling message is to be transmitted according to a first radio access technology, and configured to segment the signaling message into a plurality of segments if the transmitter is transmitting data according to the second radio access technology and to transmitted according to a first radio access technology via a transmitter transmit the plurality of segments via the transmitter wherein the signaling circuit separates the transmission of two segments by a delay, which is based on a transmission of the data.

### CROSS-REFERENCE TO RELATED APPLICATIONS

The present application is a national stage entry according to 35 U.S.C. § 371 of PCT application No.: PCT/US2016/046222 filed on Aug. 10, 2016, which claims priority from German application No.: 10 2015 116 221.0 filed on Sep. 25, 2015, and is incorporated herein by reference in its entirety.

### TECHNICAL FIELD

Embodiments described herein generally relate to communication terminals and methods for transmitting a signaling message.

### BACKGROUND

A subscriber terminal of a cellular communication network may have two SIM cards. However, to save costs, a subscriber terminal having two SIM cards may be equipped with only a single radio transmitter which thus needs to be shared by the two SIM cards. To avoid bad user experience, approaches which allow avoiding disturbances of communication via one SIM card by communication via the other SIM card, e.g. avoiding a loss in transmission quality of a voice call via one SIM card when having to transmit signaling data via the other SIM card are desirable.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows a communication system according to an embodiment, e.g. an LTE (Long Term Evolution) communication system.

FIG. 2 shows a frame of an exemplary frame structure.

FIG. 3 shows a radio cell arrangement according to an embodiment.

FIG. 4 shows a communication terminal.

FIG. 5 shows a flow diagram illustrating a method for transmitting a signaling message, e.g. carried out by a communication terminal.

FIG. 6 shows a transmission diagram illustrating a long interruption of an LTE transmission.

FIG. 7 shows a transmission diagram illustrating short interruptions of an LTE transmission.

FIG. 8 illustrates the handling of segmented RB 2 and RB 3 messages and the artificial delay to be added on WCDMA MAC level in a communication terminal.

FIG. 9 shows a further transmission diagram illustrating short interruptions of an LTE transmission.

### DESCRIPTION OF EMBODIMENTS

The following detailed description refers to the accompanying drawings that show, by way of illustration, specific details and aspects of this disclosure in which the invention may be practiced. Other aspects may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

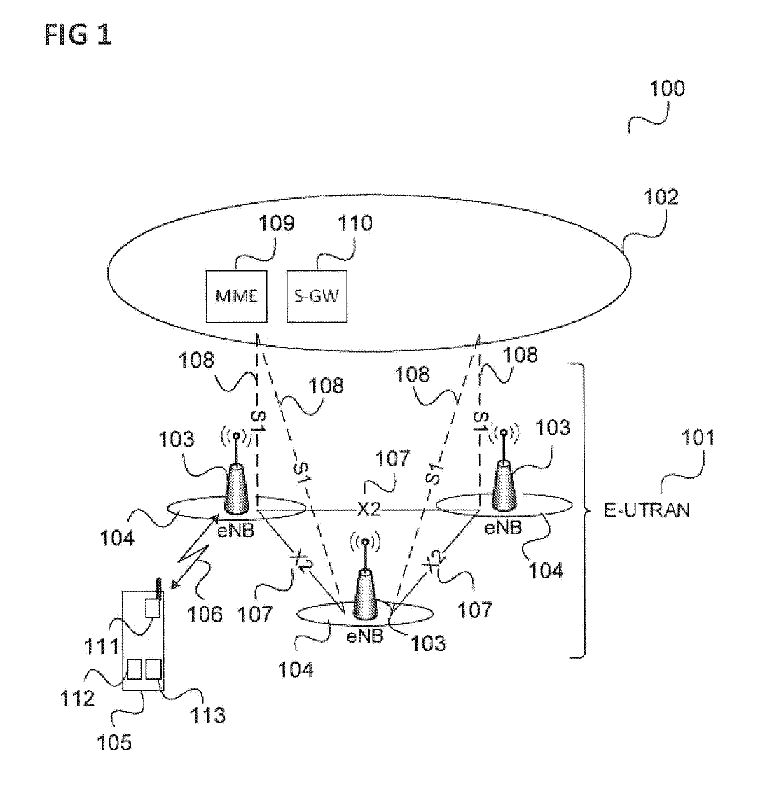

FIG. 1 shows a communication system 100 according to an embodiment, e.g. an LTE (Long Term Evolution) communication system.

The communication system 100 includes a radio access network (e.g. an E-UTRAN, Evolved UMTS (Universal Mobile Communications System) Terrestrial Radio Access Network according to LTE) 101 and a core network (e.g. an EPC, Evolved Packet Core, according LTE) 102. The radio access network 101 may include base (transceiver) stations (e.g. eNodeBs, eNBs, according to LTE) 103. Each base station 103 provides radio coverage for one or more mobile radio cells 104 of the radio access network 101.

A mobile terminal (also referred to as UE, user equipment, or MS, mobile station) 105 located in a mobile radio cell 104 may communicate with the core network 102 and with other mobile terminals 105 via the base station providing coverage in (in other words operating) the mobile radio cell.

Control and user data are transmitted between a base station 103 and a mobile terminal 105 located in the mobile radio cell 104 operated by the base station 103 over the air interface 106 on the basis of a multiple access method.

The base stations 103 are interconnected with each other by means of a first interface 107, e.g. an X2 interface. The base stations 103 are also connected by means of a second interface 108, e.g. an S1 interface, to the core network, e.g. to an MME (Mobility Management Entity) 109, and a Serving Gateway (S-GW) 110. For example, the MME 109 is responsible for controlling the mobility of mobile terminals located in the coverage area of E-UTRAN, while the S-GW 110 is responsible for handling the transmission of user data between mobile terminals 105 and core network 102.

The radio access network 101 and the core network may support communication according to various communication technologies, e.g. mobile communication standards. For example, each base station 103 may provide a radio communication connection via the air interface between itself and the mobile terminal 105 according to LTE, UMTS, GSM (Global System for Mobile Communications), EDGE (Enhanced Data Rates for GSM Evolution) radio access. Accordingly, the radio access network 102 may operate as an E-UTRAN, a UTRAN, a GSM radio access network, or a GERAN (GSM EDGE Radio Access Network). Analogously, the core network 102 may include the functionality of an EPC, a UMTS core network or a GSM core network.

For uplink radio communication via the air interface 106, the mobile terminal 105 includes a radio transmitter (TX RF) 111.

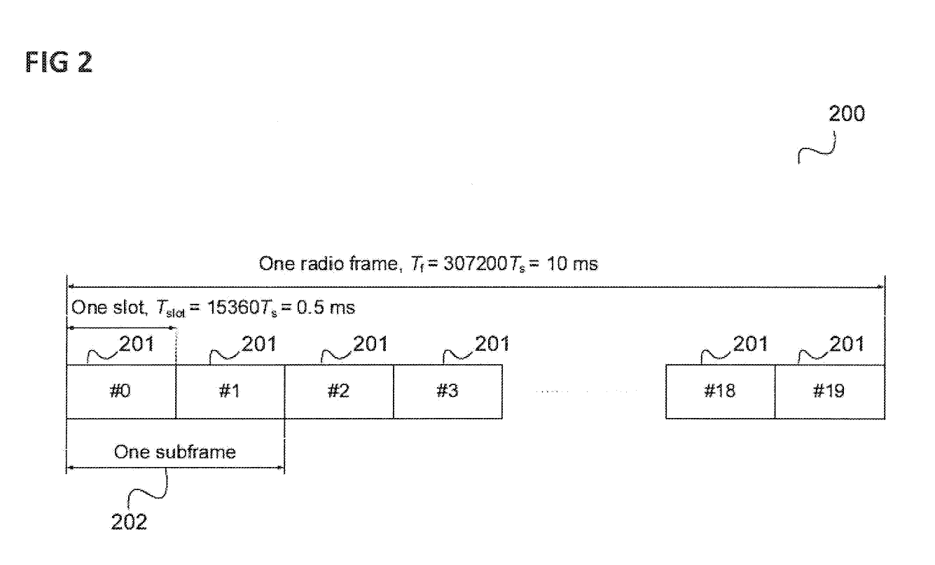

Data transmission between the mobile terminal 105 and the corresponding base station 103 (i.e. the base station operating the radio cell in which the mobile terminal 105 is located) is carried out in accordance with a (radio) frame structure. An example of a frame structure is shown in FIG. 2.

FIG. 2 shows a frame 200 of an exemplary frame structure.

The frame 200 may be used for both full-duplex and half-duplex FDD. The frame 200 is 10 ms long and consists of 20 slots 201 of length 0.5 ms, numbered from 0 to 19. A subframe 202 is defined as two consecutive slots 201. In each 10 ms interval ten subframes 202 are available for downlink transmissions or uplink transmissions, i.e. as time transmission intervals (TTI). It should however be noted that according to other radio access technologies like e.g. WIFI, a frame may have a different number of subframes than ten and a subframe may include more than two slots.

Uplink and downlink transmissions are separated in the frequency domain. Depending on the slot format a subframe 202 may include 12 or 14 OFDM (orthogonal frequency division multiple access) symbols in DL (downlink) and 12 or 14 SC-FDMA symbols in UL (uplink), respectively.

The mobile terminal 105 may include an identity module 112 (e.g. implemented by a chip card) that allows the mobile terminal 105 to identify itself as a subscriber of the communication network (e.g. as an LTE subscriber) formed by the radio access network 101 and the core network 102 and thus to use the communication network as a home network.

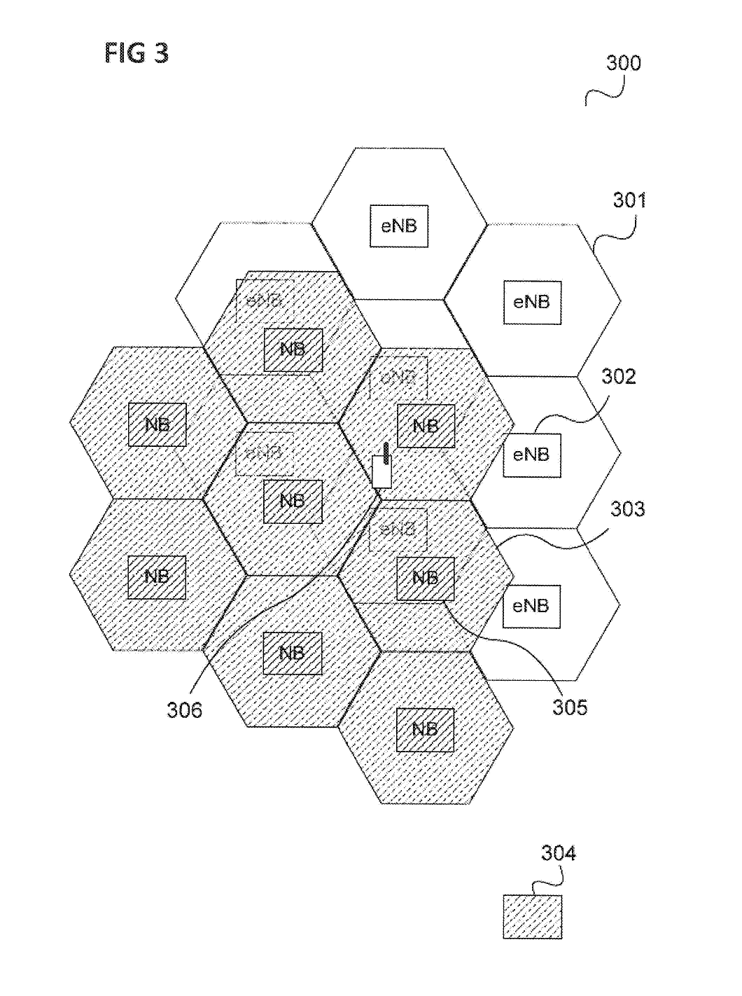

The mobile terminal 105 may include a further identity module 113, i.e. may be a multi-SIM device that allows the mobile terminal 105 also to use another communication network (e.g. WCDMA (Wideband Code Division Multiple Access) network such as a UMTS network) since in practice, a plurality of cellular communication networks are provided by different operators and according to different radio access technologies (e.g. LTE and UMTS) such that the coverage areas of the communication networks overlap, i.e. a mobile terminal may be located within a radio cell 104 operated by a base station 103 belonging to a first communication network of a first operator according to a first radio access technology (e.g. LTE) and at the same time be located within a radio cell operated by a base station 103 belonging to a second communication network of a second operator according to a second radio access technology (e.g. UMTS). This is illustrated in FIG. 3.

FIG. 3 shows a radio cell arrangement 300 according to an embodiment.

The radio cell arrangement 300 includes a first plurality of radio cells 301 (shown without hatching) operated by a plurality of first base stations 302 of a first communication network (e.g. LTE base stations eNB), and a second plurality of radio cells 303 indicated by a hatching 304 operated by a plurality of second base stations 305 of a second communication network (e.g. UMTS base stations NB).

As illustrated, the second plurality of radio cells 303 overlaps the first plurality of radio cells 304 such that a mobile terminal 306, e.g. corresponding to mobile terminal 105, located in the overlapping area may connect to both the first communication network and the second communication network, e.g. may both register with a base station 302 of the first communication network and a base station 305 of the second communication network.

The mobile terminal 306 may communicate with the first communication network by means of its LTE identity module 112, i.e. under the subscription of its first identity module 112, and may communicate with the second communication network by means of its UMTS identity module 113, i.e. under the subscription of its second identity module 112, and may for example have a radio receiver for LTE reception (downlink communication) and a further radio receiver for simultaneous UMTS reception.

However, the mobile terminal 306 may have only a single radio transmitter 111 (or radio transmitter path) to save costs, e.g. a single transmit antenna or a single one of a corresponding transmit frontend module component (while, for example having both an LTE baseband circuit and a UMTS baseband circuit). For example, the mobile terminal 306 includes a multi-SIM modem that supports LTE and WCDMA uplink communication with a single radio transmitter (TX RF path) by sharing the TX RF path between LTE and WCDMA in uplink direction. This means the TX RF path toggles between LTE and WCDMA. This can be seen as a reduced DSDA (Dual SIM Dual Active) functionality and is for example referred to as LTE/3G TXT (Transmit Toggling).

However, if the mobile terminal 306 (UE) is in LTE connected mode (e.g. for a VoLTE call) on its LTE SIM and a WCDMA signaling only procedure needs to be executed in parallel for the WCDMA (e.g. UMTS) SIM, e.g. to get the Caller ID of an incoming call or to perform a Location Area Update/Routing Area Update, which requires a relatively large WCDMA Radio Bearer 2 or 3 uplink signaling message, the transmission of the signaling message interrupts the LTE UL transmission for a relatively long time period since the signaling message is typically segmented and transmitted in several successive WCDMA TTIs. This can create degradation in user experience of the LTE connection like noticeable worse audio quality or lower throughput.

In the following, a communication terminal is described that may, for example, reduce the negative impact on user experience for an LTE connection while a WCDMA signaling only procedure is run in parallel to the LTE connection.

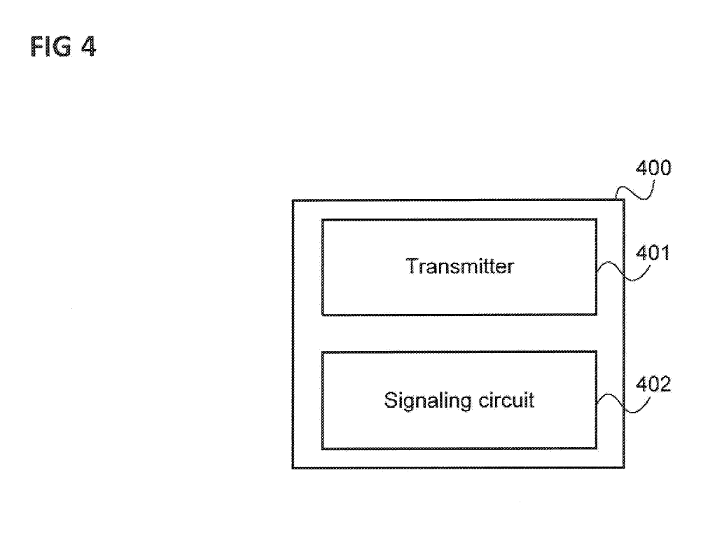

FIG. 4 shows a communication terminal 400.

The communication terminal 400 comprises a transmitter 401 and a signaling circuit 402 configured to determine whether the transmitter is transmitting data according to a second radio access technology, while a signaling message is to be transmitted according to a first radio access technology (RAT) and configured to segment the signaling message into a plurality of segments if the transmitter is transmitting data according to the second radio access technology and to transmit the plurality of segments via the transmitter wherein the signaling circuit 402 separates the transmission of two segments by a delay which is based on a transmission of the data.

In other words, a signaling circuit such as signaling circuit 402 is configured to detect, when a signaling message is to be transmitted via a transmitter, e.g. indicated by the request from another component of the communication terminal 400, whether the transmitter is currently used for transmission of data, e.g. for a communication connection such as a voice call. If this is the case, the signaling circuit transmits the signaling message in segments such that between the transmission of two segments, the data transmitted in accordance with the second RAT may be transmitted, i.e. the transmission of the data is only interrupted for the duration of the transmission of a segment instead of the whole signaling message. In other words, every two segments of the plurality of segments are separated by (at least) a delay corresponding to the transmission of the data (e.g. a time interval during which a part of the data is transmitted). For example, the communication terminal may be configured to treat certain types of data transmissions over the first RAT such as voice calls with preference over signaling messages or certain types of signaling messages in the sense that it segments signaling messages of a first RAT if there is a data transmission of such a type (such as a voice call) on a second RAT. For example, the communication terminal may be configured to treat real-time connections with preference over signaling messages or certain types of signaling messages in that sense. Information about the preference of a data transmission or a communication connection over signaling messages may for example be stored in a memory of the communication terminal.

For example, in a communication terminal supporting an LTE connection in parallel to WCDMA signaling (e.g. having a Multi-SIM modem), the communication terminal segments WCDMA radio bearer 2 or 3 uplink messages (e.g. for a first SIM) into segments corresponding to several uplink TTIs using a R99 DCH channel configuration, which avoids transmitting these segments in successive TTIs in case a LTE connection (for second SIM) is active. Instead, the communication terminal spreads the UL transmission of the segmented signaling messages over a longer time period, e.g. in WCDMA connected mode.

This allows reducing the impact on the Uplink of LTE in connected mode on the second SIM while having a WCDMA signaling procedure running in parallel on the first SIM in a Multi-SIM platform with a single radio transmitter since the LTE UL transmission is interrupted for smaller time durations as in case the WCDMA signaling message segments are transmitted in consecutive TTIs. This for example reduces the risk that LTE HARQ procedures are failing for the LTE connection which means a reduced degradation in LTE throughput. For example, for a VoLTE call less successive UL audio packages are affected by the WCDMA signaling which should also improve the audio quality of the VoLTE call.

The components of the communication terminal (e.g. the transmitter and the signaling circuit) may for example be implemented by one or more circuits. A “circuit” may be understood as any kind of a logic implementing entity, which may be special purpose circuitry or a processor executing software stored in a memory, firmware, or any combination thereof. Thus a “circuit” may be a hard-wired logic circuit or a programmable logic circuit such as a programmable processor, e.g. a microprocessor. A “circuit” may also be a processor executing software, e.g. any kind of computer program. Any other kind of implementation of the respective functions which will be described in more detail below may also be understood as a “circuit”.

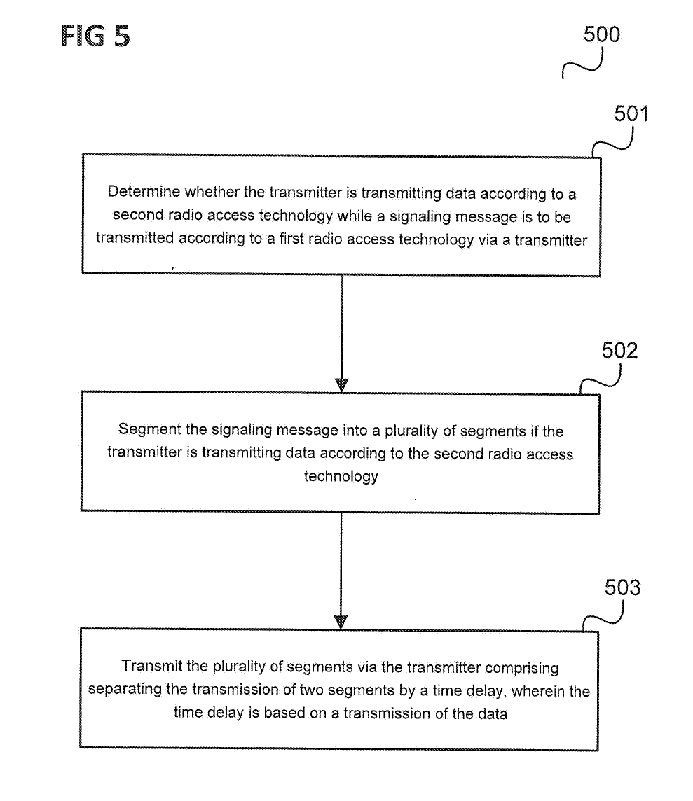

The communication terminal 400 for example performs a method as illustrated in FIG. 5.

FIG. 5 shows a flow diagram 500 illustrating a method for transmitting a signaling message, e.g. carried out by a communication terminal.

In 501, the communication terminal determines whether the transmitter is transmitting data according to a second radio access technology while a signaling message is to be transmitted according to a first radio access technology via a transmitter.

In 502 the communication terminal segments the signaling message into a plurality of segments if the transmitter is transmitting data according to the second radio access technology.

In 503, the communication terminal transmits the plurality of segments via the transmitter comprising separating the transmission of two segments by a time delay, wherein the time delay is based on a transmission of the data.

The following examples pertain to further embodiments.

Example 1 is a communication terminal as illustrated in FIG. 4.

In Example 2, the subject matter of Examples 1 may optionally include the signaling circuit being configured to determine whether the transmitter is transmitting data according to the second radio access technology in response to a request to transmit a signaling message.

In Example 3, the subject matter of any one of Examples 1-2 may optionally include the signaling circuit being configured to determine whether the transmitter is transmitting data according to the second radio access technology in response to the reception of a request to transmit a signaling message from another component of the communication terminal.

In Example 4, the subject matter of any one of Examples 1-3 may optionally include transmitting data according to the second radio access technology being transmitting data via a communication connection according to the second radio access technology.

In Example 5, the subject matter of any one of Examples 1-4 may optionally include the data being voice data of a call according to the second radio access technology.

In Example 6, the subject matter of any one of Examples 1-5 may optionally include the signaling message including signaling data and the signaling circuit being configured to transmit a further signaling message for transmitting further signaling data and being configured to separate the transmission of each segment of the plurality of segments from the transmission of the further signaling message by a further delay based on a further transmission of the data.

In Example 7, the subject matter of any one of Examples 1-6 may optionally include each segment having a length fitting in one transmission time interval of a frame structure of the first radio access technology.

In Example 8, the subject matter of any one of Examples 1-7 may optionally include the signaling message having a length larger than a transmission time interval of a frame structure of the first radio access technology.

In Example 9, the subject matter of any one of Examples 1-8 may optionally include the signaling circuit being configured to transmit each segment in a time transmission interval according to a frame structure of the first radio access technology and, for every two segments of the signaling message, the signaling circuit being configured to separate the transmission of the two segments by at least one time transmission interval according to a frame structure of the first radio access technology.

In Example 10, the subject matter of any one of Examples 1-9 may optionally include the signaling circuit being configured to transmit each segment in a time transmission interval according to a frame structure of the first radio access technology and the signaling circuit being configured to transmit a further signaling message and being configured to separate the transmission of each segment from each other segment and from the transmission of the further signaling message by at least one time transmission interval according to a frame structure of the first radio access technology.

In Example 11, the subject matter of any one of Examples 1-10 may optionally include the signaling circuit being configured to transmit the segments of the signaling message in transmission time intervals according to a frame structure of the first radio access technology and the signaling circuit being configured to separate every two transmission time intervals it uses for transmission of a segment by a transmission time interval free of the transmission of a segment.

In Example 12, the subject matter of any one of Examples 1-11 may optionally include the signaling circuit being configured to segment the signaling message into a number of segments depending on the length of the signaling message.

In Example 13, the subject matter of any one of Examples 1-12 may optionally include the signaling circuit being configured to, if the transmitter is not transmitting data according to the second radio access technology, transmit the signaling message in successive transmission time intervals according to the first radio access technology.

In Example 14, the subject matter of any one of Examples 1-13 may optionally include the communication terminal being a subscriber terminal of a first cellular mobile communication network according to the first radio access technology and being a subscriber terminal of a second cellular mobile communication network according to the second radio access technology.

In Example 15, the subject matter of Example 14 may optionally include the signaling message being an uplink signaling message to a base station of the first cellular mobile communication network and the transmission of data being an uplink transmission of data to a base station of the second cellular mobile communication network.

In Example 16, the subject matter of any one of Examples 14-15 may optionally include the communication terminal comprising a first subscriber identity module according to a subscription of the first cellular mobile communication network and comprising a second subscriber identity module according to a subscription of the second cellular mobile communication network and the signaling message being a signaling message under the subscription of the first cellular mobile communication network and the transmission of data being a data transmission under the subscription of the second cellular mobile communication network.

In Example 17, the subject matter of any one of Examples 1-16 may optionally include the first radio access technology being a WCDMA radio access technology.

In Example 18, the subject matter of any one of Examples 1-17 may optionally include the second radio access technology being LTE.

Example 19 is a method for transmitting a signaling message as illustrated in FIG. 5.

In Example 20, the subject matter of Example 19 may optionally include determining whether the transmitter is transmitting data according to the second radio access technology in response to a request to transmit a signaling message.

In Example 21, the subject matter of any one of Examples 19-20 may optionally include determining whether the transmitter is transmitting data according to the second radio access technology in response to the reception of a request to transmit a signaling message from another component of a communication terminal comprising the transmitter.

In Example 22, the subject matter of Example 19 may optionally include transmitting data according to the second radio access technology being transmitting data via a communication connection according to the second radio access technology.

In Example 23, the subject matter of any one of Examples 19-22 may optionally include the data being voice data of a call according to the second radio access technology.

In Example 24, the subject matter of any one of Examples 19-23 may optionally include the signaling message including signaling data and transmitting a further signaling message for transmitting further signaling data and separating the transmission of each segment of the plurality of segments from the transmission of the further signaling message by a further delay based on a further transmission of the data.

In Example 25, the subject matter of any one of Examples 19-24 may optionally include each segment having a length fitting in one transmission time interval of a frame structure of the first radio access technology.

In Example 26, the subject matter of any one of Examples 19-25 may optionally include the signaling message having a length larger than a transmission time interval of a frame structure of the first radio access technology.

In Example 27, the subject matter of any one of Examples 19-26 may optionally include transmitting each segment in a time transmission interval according to a frame structure of the first radio access technology and, for every two segments of the signaling message, separating the transmission of the two segments by at least one time transmission interval according to a frame structure of the first radio access technology.

In Example 28, the subject matter of any one of Examples 19-27 may optionally include transmitting each segment in a time transmission interval according to a frame structure of the first radio access technology and transmitting a further signaling message and separating the transmission of each segment from each other segment and from the transmission of the further signaling message by at least one time transmission interval according to a frame structure of the first radio access technology.

In Example 29, the subject matter of any one of Examples 19-28 may optionally include transmitting the segments of the signaling message in transmission time intervals according to a frame structure of the first radio access technology and separating every two transmission time intervals it uses for transmission of a segment by a transmission time interval free of the transmission of a segment.

In Example 30, the subject matter of any one of Examples 19-29 may optionally include segmenting the signaling message into a number of segments depending on the length of the signaling message.

In Example 31, the subject matter of any one of Examples 19-30 may optionally include, if the transmitter is not transmitting data according to the second radio access technology, transmitting the signaling message in successive transmission time intervals according to the first radio access technology.

In Example 32, the subject matter of any one of Examples 19-31 may be performed by a communication terminal being a subscriber terminal of a first cellular mobile communication network according to the first radio access technology and being a subscriber terminal of a second cellular mobile communication network according to the second radio access technology.

In Example 33, the subject matter of Example 32 may optionally include the signaling message being an uplink signaling message to a base station of the first cellular mobile communication network and the transmission of data being an uplink transmission of data to a base station of the second cellular mobile communication network.

In Example 34, the subject matter of any one of Examples 32-33 may optionally include the communication terminal comprising a first subscriber identity module according to a subscription of the first cellular mobile communication network and comprising a second subscriber identity module according to a subscription of the second cellular mobile communication network and the signaling message being a signaling message under the subscription of the first cellular mobile communication network and the transmission of data being a data transmission under the subscription of the second cellular mobile communication network.

In Example 35, the subject matter of any one of Examples 19-34 may optionally include the first radio access technology being a WCDMA radio access technology.

In Example 36, the subject matter of any one of Examples 19-35 may optionally include the second radio access technology being LTE.

Example 37 is a computer readable medium having recorded instructions thereon which, when executed by a processor, make the processor perform a method for transmitting a signaling message according any one of Examples 19 to 36.

It should be noted that one or more of the features of any of the examples above may be combined with any one of the other examples.

In the following, examples are described in more detail.

For the following, it is assumed that a communication terminal, e.g. corresponding to mobile terminals 105, 306 of FIGS. 1 and 3, comprises a Multi-SIM modem that supports a reduced DSDA functionality where only one TX RF 111 is available that is shared between a WCDMA SIM card (e.g. an UMTS SIM card) 113 and an LTE SIM card 112 to support being in connected mode simultaneously for both of the SIM cards 112, 113.

The communication terminal (or UE) supports LTE connected mode on the LTE SIM 112 in parallel to 3G connected mode procedures on the WCDMA SIM 113 by sharing the TX RF resource. This sharing is done by toggling the TX RF 111 between LTE communication (e.g. an LTE connection) and WCDMA communication (e.g. a WCDMA connection).

In case of a WCDMA signaling only procedure the WCDMA functionality of the terminal ideally would need the TX RF path only for the time periods when Radio Bearer (RB) 2 or 3 signaling messages or RLC messages like status updates are to be transmitted. The rest of the time the WCDMA functionality only requires UL transmission for some physical layer procedures like power control. As the duration of a signaling only connection is relatively short it is assumed that the communication terminal functions if the WCDMA physical layer procedures are active only in the time instances when real UL data needs to be send by the UE (e.g. a LTE connection does not fail during a WCDMA uplink signaling transmission).

Examples for typical WCDMA signaling only procedures are:
Receive caller ID of an incoming call (mobile terminated)
Perform a Location Area or Routing Area Update

During such signaling only phases the WCDMA network, e.g. a UMTS base station 305, for example assigns a WCDMA DCH R99 configuration to the UE 306 which can have a 10 ms, 20 ms or 40 ms UL TTI.

RLC UL messages like RLC Status updates are not segmented as the content is small enough to fit into one single WCDMA UL TTI. But most of the RB2/3 messages do not fit into a single WCDMA UL TTI and the communication terminal 306 therefore segments such a signaling message into segments corresponding to a plurality of TTIs, i.e. into segments wherein each segment may be transmitted during a single TTI. Depending on the type of message, it is segmented into two TTIs or even into several TTIs like the “Connection Setup Complete” message that for example requires eight segments (for a 10 ms UL TTI).

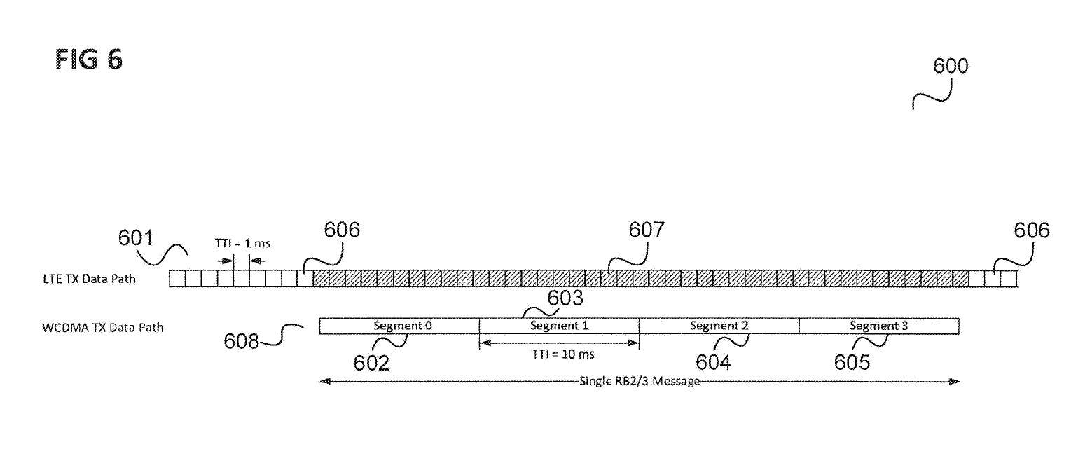

In case an LTE connection is active on the second SIM while a WCDMA signaling only procedure is running and the TX RF path needs to be shared then the transmission of the segmented RB2/3 message on WCDMA in successive TTIs, may, for a larger message corresponding to several TTIs lead to gaps for the LTE TX path as illustrated in FIG. 6.

FIG. 6 shows a transmission diagram 600.

Time flows from left to right in FIG. 6 and transmission activities are shown for a LTE TX Data path representation 601 and a WCDMA TX Data path representation 608.

In this example a WCDMA RB2/3 signaling message is split into four segments 602, 603, 604, 605 which are transmitted in four successive WCDMA TTIs where each WCDMA TTI has a length of 10 ms. As can be seen, in this example the LTE uplink transmission of data 606 is interrupted (indicated by hatched LTE TTIs 607) for 40 ms so that for 40 LTE UL TTIs (with 1 ms each) data as well as the HARQ ACK for received DL messages cannot be transmitted via the LTE TX Data path. This can lead to noticeable audio degradation of a VoLTE call or reduced UL/DL throughput as HARQ can fail requiring LTE RLC retransmission which is a much slower process than HARQ.

To avoid this, in this example the transmission of the segments of the WCDMA RB2/3 message is spread over time, i.e. the segments are not transmitted in successive WCDMA TTIs, but a (artificial) delay is introduced after the transmission of a segment until the transmission of the subsequent segment.

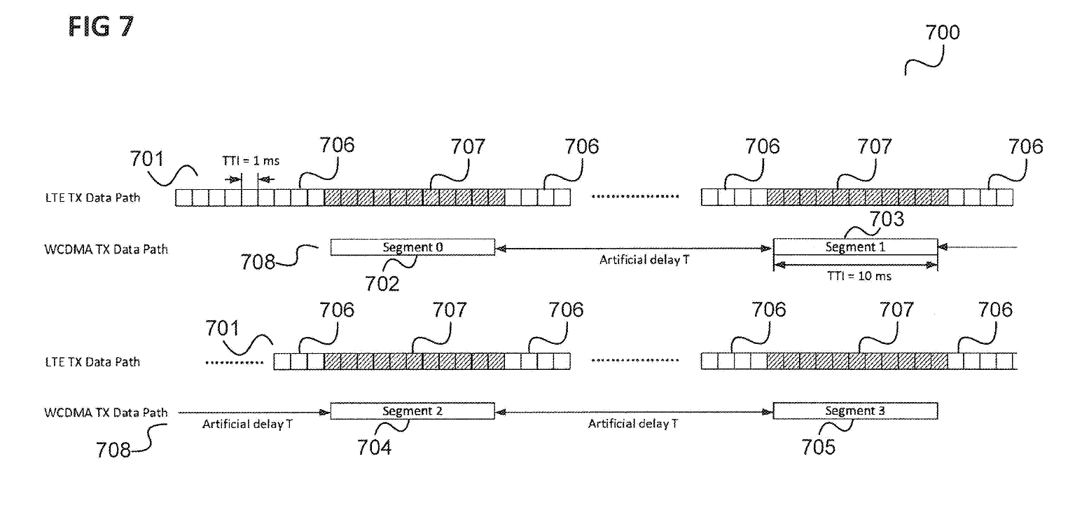

This is illustrated in FIG. 7.

FIG. 7 shows a transmission diagram 700.

Time flows from left to right in FIG. 7 and transmission activities are shown for a LTE TX Data path representation 701 and for a WCDMA TX Data path representation 708.

As in the example of FIG. 6, a WCDMA RB2/3 signaling message is split into four segments 702, 703, 704, 705 in this example. However, the segments 702, 703, 704, 705 are transmitted in WCDMA TTIs separated by delays 706.

Thus, compared with FIG. 6, there are smaller interruptions (indicated by hatched LTE TTIs 707) of the LTE uplink transmission of data 706 and thus smaller interruptions for an LTE UL connection that is active in parallel to the WCDMA signaling which, for example, should therefore have less impact on throughput or audio quality of the LTE connection.

The value of the delay 706 may for example be chosen depending on the WCDMA R99 UL TTI duration configured by the WCDMA communication network). It may for example have a length of one to several WCDMA TTIs.

The communication terminal 306 may for example introduce the delay 706 at the WCDMA MAC layer as this layer controls at which time which UL data shall be sent in each WCDMA UL TTI.

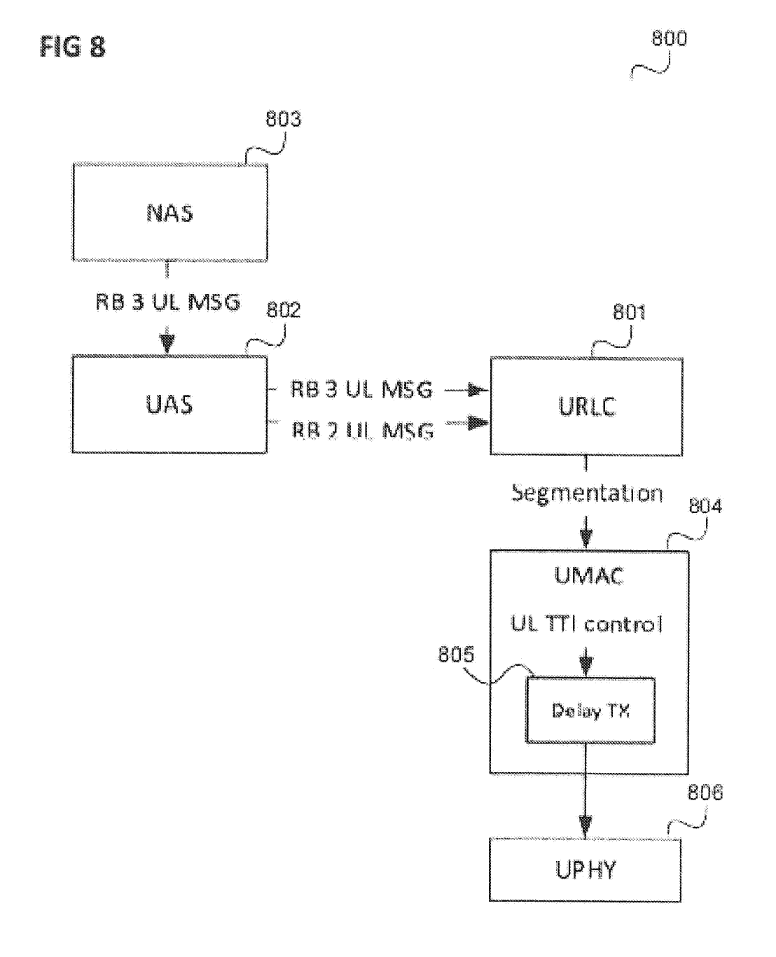

FIG. 8 illustrates the handling of segmented RB2 and RB3 messages and the artificial delay to be added on WCDMA MAC level in a communication terminal.

A (WCDMA) RLC component 801 is provided with an RB 2 UL signaling message or an RB 3 UL signaling message by a AS (Access Stratum) component 802 or a NAS (non access stratum) component 803. In other words, the RLC component 801 is provided with a signaling message and requested to transmit the signaling message. The RLC component 801 determines whether the signaling message is too large to be transmitted in a single WCDMA TTI and, assuming in this example that this is the case, the RLC component 801 segments the signaling message into a plurality of segments and provides the segments for transmission to a MAC layer component 804.

The MAC layer component 804 determines whether there is a simultaneous LTE connection which is to be treated with preference over the signaling message such as an VoLTE call and if this is the case, introduces a delay 805 between the segments, i.e. forwards the segments to the physical layer 806 with a delay between subsequent segments.

Depending on the introduced delay the network side may detect missing RLC blocks and may thus request a retransmission. If the RLC component 801 on the UE side receives such a retransmission request it may for example ignore it until all the MAC layer component 804 has sent out all segments.

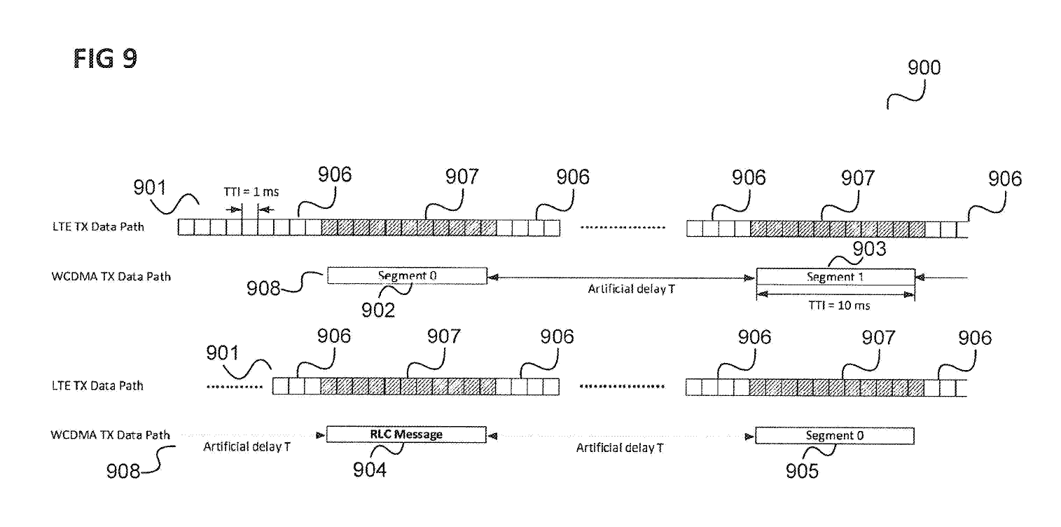

Besides adding an UL delay for RB2/3 signaling messages the MAC layer 804 can also artificially delay RLC signaling messages (such as status reports, ACKs, RLC reset message) so that in the end all single UL TTIs which do contain RB2/3 signaling message data or RLC signaling message data have a minimum distance to each other. This is illustrated in FIG. 9.

FIG. 9 shows a transmission diagram 900.

Time flows from left to right in FIG. 9 and transmission activities are shown for a LTE TX Data path representation 901 and for a WCDMA TX Data path representation 908.

In this example two segments 902, 903 of a first RB2/3 signaling message, an RLC signaling message 904 and a segment 905 of a second RB2/3 signaling message are transmitted.

The segments 902, 903, 905 and the RLC signaling message 904 are transmitted in WCDMA TTIs separated by delays 906.

Thus, it is ensured that also in case of a plurality of messages being transmitted (two RB2/3 signaling messages and an RLC message in this example), that the interruptions (indicated by hatched LTE TTIs 907) of the LTE uplink transmission of data 906 are limited to one WCDMA TTI.

While specific aspects have been described, it should be understood by those skilled in the art that various changes in form and detail may be made therein without departing from the spirit and scope of the aspects of this disclosure as defined by the appended claims. The scope is thus indicated by the appended claims and all changes which come within the meaning and range of equivalency of the claims are therefore intended to be embraced.

1. A communication terminal, comprising:
a transmitter;
a signaling circuit configured to, determine whether the transmitter is transmitting data according to a second radio access technology, while a signaling message is to be transmitted according to a first radio access technology;
and configured to segment the signaling message into a plurality of segments if the transmitter is transmitting data according to the second radio access technology and to transmit the plurality of segments via the transmitter;
wherein the signaling circuit separates the transmission of two segments by a delay, which is based on a transmission of the data.

2. The communication terminal of claim 1, wherein the signaling circuit is configured to determine whether the transmitter is transmitting data according to the second radio access technology in response to a request to transmit a signaling message.

3. The communication terminal of claim 1, wherein the signaling circuit is configured to determine whether the transmitter is transmitting data according to the second radio access technology in response to the reception of a request to transmit a signaling message from another component of the communication terminal.

4. The communication terminal of claim 1, wherein transmitting data according to the second radio access technology is transmitting data via a communication connection according to the second radio access technology.

5. The communication terminal of claim 1, wherein the data is voice data of a call according to the second radio access technology.

6. The communication terminal of claim 1, wherein the signaling message includes signaling data and wherein the signaling circuit is configured to transmit a further signaling message for transmitting further signaling data and is configured to separate the transmission of each segment of the plurality of segments from the transmission of the further signaling message by a further delay based on a further transmission of the data.

7. The communication terminal of claim 1, wherein each segment has a length fitting in one transmission time interval of a frame structure of the first radio access technology.

8. The communication terminal of claim 1, wherein the signaling message has a length larger than a transmission time interval of a frame structure of the first radio access technology.

9. The communication terminal of claim 1, wherein the signaling circuit is configured to transmit each segment in a time transmission interval according to a frame structure of the first radio access technology and, for every two segments of the signaling message, the signaling circuit is configured to separate the transmission of the two segments by at least one time transmission interval according to a frame structure of the first radio access technology.

10. The communication terminal of claim 1, wherein the signaling circuit is configured to transmit each segment in a time transmission interval according to a frame structure of the first radio access technology and wherein the signaling circuit is configured to transmit a further signaling message and is configured to separate the transmission of each segment from each other segment and from the transmission of the further signaling message by at least one time transmission interval according to a frame structure of the first radio access technology.

11. The communication terminal of claim 1, wherein the signaling circuit is configured to transmit the segments of the signaling message in transmission time intervals according to a frame structure of the first radio access technology and wherein the signaling circuit is configured to separate every two transmission time intervals it uses for transmission of a segment by a transmission time interval free of the transmission of a segment.

12. The communication terminal of claim 1, wherein the signaling circuit is configured to segment the signaling message into a number of segments depending on the length of the signaling message.

13. The communication terminal of claim 1, wherein the signaling circuit is configured to, if the transmitter is not transmitting data according to the second radio access technology, transmit the signaling message in successive transmission time intervals according to the first radio access technology.

14. The communication terminal of claim 1, wherein the communication terminal is a subscriber terminal of a first cellular mobile communication network according to the first radio access technology and is a subscriber terminal of a second cellular mobile communication network according to the second radio access technology.

15. The communication terminal of claim 14, wherein the signaling message is an uplink signaling message to a base station of the first cellular mobile communication network and the transmission of data is an uplink transmission of data to a base station of the second cellular mobile communication network.

16. The communication terminal of claim 14, wherein the communication terminal comprises a first subscriber identity module according to a subscription of the first cellular mobile communication network and comprises a second subscriber identity module according to a subscription of the second cellular mobile communication network and wherein the signaling message is a signaling message under the subscription of the first cellular mobile communication network and the transmission of data is a data transmission under the subscription of the second cellular mobile communication network.

17. The communication terminal of claim 1, wherein the first radio access technology is a WCDMA radio access technology.

18. The communication terminal of claim 1, wherein the second radio access technology is LTE.

19. A method for transmitting a signaling message comprising:
determining whether the transmitter is transmitting data according to a second radio access technology while a signaling message is to be transmitted according to a first radio access technology via a transmitter;
segmenting the signaling message into a plurality of segments if the transmitter is transmitting data according to the second radio access technology; and
transmitting the plurality of segments via the transmitter comprising separating the transmission of two segments by a time delay, wherein the time delay is based on a transmission of the data.

20-24. (canceled)

25. A computer readable medium having recorded instructions thereon which, when executed by a processor, make the processor perform a method for transmitting a signaling message according to claim 19.
